(19) United States
(12) Patent Application Publication
(10) Pub. No.: US 2021/0146588 A1
(43) Pub. Date: May 20, 2021

(54) METHOD FOR PRODUCING A FILM FOR A COMPOSITE PANE, METHOD FOR PRODUCING THE COMPOSITE PANE, AND COMPOSITE PANE

(71) Applicant: Dr. Ing. h.c. F. Porsche Aktiengesellschaft, Stuttgart (DE)

(72) Inventors: Marek Patschger, Leonberg (DE); Stephan Wetzel, Weissach (DE)

(21) Appl. No.: 16/950,184

(22) Filed: Nov. 17, 2020

(30) Foreign Application Priority Data
Nov. 20, 2019 (DE) 10 2019 131 305.8

(51) Int. Cl. B29C 48/00; B32B 27/08; B32B 27/30; B32B 27/16; B29C 48/08; B32B 27/20

(52) U.S. Cl. CPC B29C 48/0021; B32B 27/08; B32B 27/306; B32B 27/16; B29C 48/022; B32B 2038/0052; B32B 27/20; B32B 2307/4026; B32B 2315/10; B32B 2605/006; B29C 48/08

(57) ABSTRACT

A method for producing a film for a composite pane of a motor vehicle, which film serves as an intermediate layer of the composite pane, comprising the following steps: providing a polyvinyl butyral (PVB) film base material or an ethylene vinyl acetate copolymer (EVA) film base material; providing at least one colorant; mixing the PVB or EVA film base material with the at least one colorant; liquefying the mixture of the PVB or EVA film base material and the at least one colorant; extruding the film from the liquefied mixture of the PVB or EVA film base material and the at least one colorant; treating the extruded film section by section by irradiating the film in order to form sections of different light transmissivity.

### CROSS-REFERENCE TO PRIOR APPLICATIONS

Priority is claimed to German Patent Application No. DE 10 2019 131 305.8, filed on Nov. 20, 2019, the entire disclosure of which is hereby incorporated by reference herein.

### FIELD

The present disclosure relates to a method for producing a film for a composite pane of a motor vehicle, to a method for producing the composite pane, and to a composite pane of a motor vehicle.

### BACKGROUND

So-called composite panes are used as windowpanes in motor vehicles. A composite pane has an inner pane, an outer pane and at least one intermediate layer arranged between the inner pane and the outer pane. In this regard, EP 1 060 876 B1 discloses a composite pane in which an intermediate layer comprising at least two thermoplastic PVB films and a PET film arranged between the PVB films is arranged between an inner pane and an outer pane. EP 1 549 490 B1 discloses a further composite pane comprising two glass panes and a film laminated between the glass panes. The laminated film is a PET film according to this prior art. WO 2017/157660 A1 also discloses a composite pane comprising an inner pane, an outer pane and an intermediate layer arranged between the inner pane and the outer pane.

Rear windows, glass roofs and the rear side glazing of motor vehicles are typically embodied as so-called privacy glazing having a low light transmissivity. A windshield of a motor vehicle is also colored particularly along the roof edge with a gray tinted strip having a low light transmissivity for protection against the sun. If the intention is to arrange behind the gray tinted strip a brake luminaire in the region of the rear window or a camera in the region of the windshield, for example, then the light transmissivity of the rear window and of the windshield is insufficient in the region of the gray tinted strip.

It is known from the art, in the region of the rear window and in the region of the windshield, at the place where a brake luminaire or a camera is arranged later in a state installed in the motor vehicle, to cut out an intermediate layer arranged between the inner pane and the outer pane of the respective composite pane, said intermediate layer reducing the light transmissivity, and to insert there a lighter film having a higher light transmissivity in order to ensure a sufficient high light transmissivity for the brake luminaire or the camera. Such a process is complex and expensive, however, since firstly different films have to be produced and secondly the different films have to be tailored to one another with an accurate fit.

EP 2 822 728 B1 and EP 2 325 002 B1 each disclose methods for producing a composite pane with a sensor window. According to EP 2 325 002 B1, the composite pane comprises between the inner pane and the outer pane two PVB films and a PET film arranged between the two PVB films with a metal coating, a stripped region being introduced in the metal coating, specifically by laser treatment on the metal-coated PET film. In EP 2 822 728 B1, too, the sensor window is provided by a stripped region being produced on a coated polymer film by means of laser treatment.

### SUMMARY

In an embodiment, the present disclosure provides a method for producing a film for a composite pane of a motor vehicle, which film serves as an intermediate layer of the composite pane, the method comprising: providing a polyvinyl butyral (PVB) film base material or an ethylene vinyl acetate copolymer (EVA) film base material, providing at least one colorant, mixing the PVB or EVA film base material with the at least one colorant, liquefying the mixture of the PVB or EVA film base material and the at least one colorant, extruding the film from the liquefied mixture of the PVB or EVA film base material and the at least one colorant, and treating the extruded film section by section by irradiating the film in order to form sections of different light transmissivity.

### BRIEF DESCRIPTION OF THE DRAWINGS

The present disclosure will be described in even greater detail below based on the exemplary figures. The disclosure is not limited to the exemplary embodiments. All features described and/or illustrated herein can be used alone or combined in different combinations in different embodiments. The features and advantages of various embodiments of the present disclosure will become apparent by reading the following detailed description with reference to the attached drawings which illustrate the following:

FIG. 1 shows a flow diagram for illustrating the method steps of a method for producing a film for a composite pane of a motor vehicle;

FIG. 2 shows a schematic plan view of a composite pane of a motor vehicle;

FIG. 3 shows a schematic cross section from FIG. 2 through the composite pane;

and

FIG. 4 shows a schematic cross section through a further composite pane of a motor vehicle.

### DETAILED DESCRIPTION

Methods known from the art or the prior art that enable a section having a higher light transmissivity to be provided locally in a composite pane of a motor vehicle are complex and therefore expensive. There is a need to simplify this.

The present disclosure provides a novel method for producing a film for a composite pane of a motor vehicle, a method for producing the composite pane using said film, and a composite pane of a motor vehicle using said film.

A method according to the present disclosure for producing a film for a composite pane comprises the following steps: providing a polyvinyl butyral (PVB) film base material or an ethylene vinyl acetate copolymer (EVA) film base material; providing at least one colorant; mixing the PVB or EVA film base material with the at least one colorant; liquefying the mixture of the PVB or EVA film base material and the at least one colorant; extruding the film from the liquefied mixture of the PVB or EVA film base material and the at least one colorant; treating the extruded film section by section by irradiating the film in order to form sections of different light transmissivity.

The disclosure proposes for the first time a film for a composite pane of a motor vehicle in which sections of different light transmissivity are provided by an extruded film, which consists of a PVB film base material or an EVA film base material and colorants embedded into the film base material, being irradiated section by section in order thus to form the sections of different light transmissivity. A defined energy input into the film is effected by way of the irradiation, as a result of which the bonding state of the colorants in the film base material is changed. A film having sections of different light transmissivity can thereby be provided in a simple manner.

After the process of extruding the film made from the film base material and the colorants embedded into the film base material, the colorants assume a bonding state in the film base material of the extruded film in which electrons in an outer electron shell of the colorants are readily mobile and can therefore well absorb defined wavelength components of the light shining through the film. Accordingly, the extruded film initially has a low light transmissivity.

As a result of said film being irradiated section by section, the bonding state of the electrons in the outer electron shell of the colorants with the film base material is changed, specifically in such a way that the mobility of the electrons is reduced, such that the latter then absorb light to a lesser extent, as a result of which the light transmissivity of the extruded film in the irradiated sections thereof is ultimately increased.

Irradiating the extruded film accordingly enables sections of different light transmissivity to be formed in a simple and reliable manner in order thus to form a section of high light transmissivity for example in the region of a rear window or else in the region of a windshield of the motor vehicle, for example for a camera positioned in the region of the pane or a luminaire positioned in the region of the pane.

In such sections of the extruded film in which the latter is irradiated, the light transmissivity of the extruded film is accordingly increased.

According to one advantageous development, the PVB or EVA film base material and the at least one colorant are provided in each case in powder form. The pulverulent PVB or EVA film base material and the at least one pulverulent colorant are mixed. The powder mixture is liquefied and extruded. As a result of respective pulverulent components being used and mixed, it is possible to ensure particularly good intermixing of the film base material and the at least one colorant before liquefying.

Preferably, the at least one colorant comprises a mica mineral coated with at least one metal oxide and/or at least one metal oxide embedded into a polymer matrix. These colorants are particularly suitable for setting the bonding state of the electrons in the outer electron shell with respect to the surroundings of the film base material in a targeted manner by irradiation.

The metal oxide is preferably a doped metal oxide. This is preferred in order to set the bonding state of the electrons in the outer electron shell with respect to the surroundings of the film base material in a targeted manner by irradiation.

According to one advantageous development, the extruded film is treated by laser irradiation section by section using a UV laser or using an IR laser. Irradiating the film section by section using a UV laser or using an IR laser is particularly preferred for forming the sections of different light transmissivity on the film.

The present disclosure relates to a composite pane of a motor vehicle, to a method for producing such a composite pane, and to a method for producing a film which serves as an intermediate layer in the composite pane or is a constituent part of an intermediate layer of the composite pane.

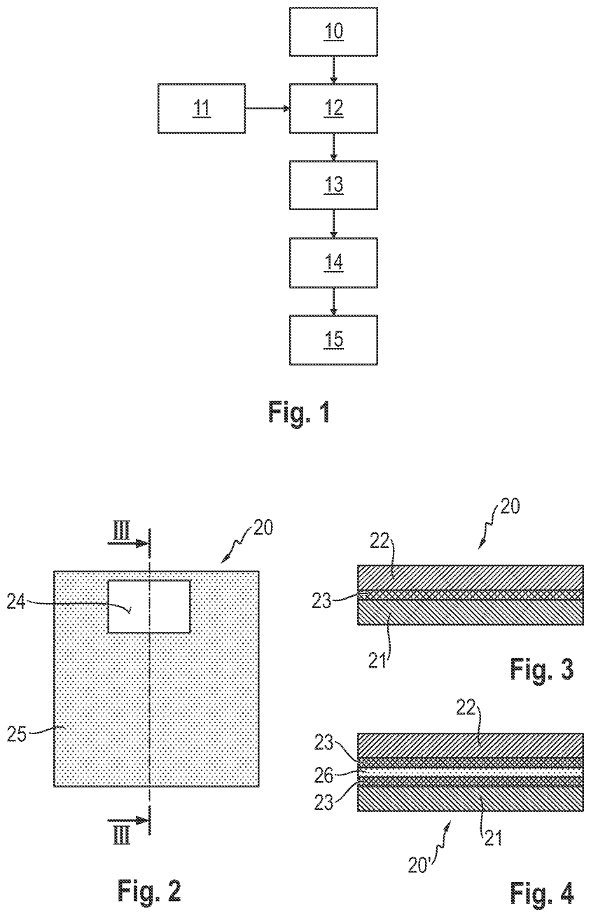

FIG. 1 shows a flow diagram of a method for producing a film for a composite pane of a motor vehicle, which film serves as an intermediate layer of the composite pane or is a constituent part of such an intermediate layer.

A step 10 of the method involves providing a film base material for the film to be produced, wherein said film base material is either a PVB film base material or an EVA film base material. In this case, PVB stands for polyvinyl butyral, and EVA stands for ethylene vinyl acetate copolymer.

The film base material is preferably provided in powder form. The pulverulent film base material preferably has an average particle size of a maximum of 250 μm, in particular an average particle size of between 50 μm and 200 μm.

A step 11 involves providing at least one colorant. The respective colorant can be a mixture of organic substances and/or inorganic substances.

The at least one colorant is preferably provided in powder form. The pulverulent colorant preferably has an average particle size of a maximum of 5 μm, in particular an average particle size of between 50 μm and 100 μm.

In this case, the at least one colorant preferably comprises a mica mineral coated with at least one metal oxide and/or at least one metal oxide embedded into a polymer matrix.

In this case, preferably doped metal oxide can be used as metal oxide.

In particular, titanium oxide and/or iron oxide and/or tin oxide are/is suitable as metal oxide. Antimony trioxide can also be used.

In particular, antimony-doped tin oxide is suitable as doped metal oxide.

A step 12 involves mixing the pulverulent film base material, that is to say the PVB film base material or the EVA film base material, and the at least one pulverulent colorant.

A step 13 involves liquefying the pulverulent mixture of the pulverulent PVB or EVA film base material and the at least one pulverulent colorant.

A step 14 involves extruding the film from the liquefied mixture of the film base material and the at least one colorant. In this case, the extruding is effected in a known manner via a nozzle with subsequent cooling of the extruded film.

After the film has been extruded in step 14, the extruded film is irradiated section by section in a step 15, specifically by means of a laser, in particular by means of a UV laser or an IR laser.

The colorants embedded into the film base material after extrusion have per se electrons which are readily mobile in an outer electron shell, such that the extruded film has a low light transmissivity after extruding and before irradiating.

As a result of the irradiation, namely laser irradiation, of the extruded film section by section, the bonding state of the electrons in the outer electron shell of the colorant with the chemical surroundings of the film base material is changed. The bonding state of the electrons is changed in such a way that the mobility of the electrons is reduced, as a result of which the light transmissivity in the irradiated sections of the extruded film is then increased since the light absorption of the colorants is reduced as a result of the irradiation.

As already explained, the or each colorant used comprises at least one metal oxide, preferably a doped metal oxide, which either is embedded into a polymer matrix or with which a mica mineral is coated.

Titanium oxide, iron oxide, tin oxide are suitable as metal oxides.

Antimony can be used for doping.

The film produced according to the present disclosure can be used for producing a composite pane of a motor vehicle, wherein the film is arranged between an inner pane of the composite pane and an outer pane of the composite pane, in particular by lamination.

The lamination of the film between the inner pane of the composite pane and the outer pane of the composite pane of the motor vehicle can be effected in a manner known from the prior art.

FIG. 2 shows highly schematically a plan view of a composite pane 20 of a motor vehicle. FIG. 3 shows the cross section from FIG. 2.

The composite pane in FIGS. 2, 3 has an inner pane 21 and an outer pane 22 and a film 23 positioned between the inner pane 21 and the outer pane 22, which film was produced in the manner described.

In order to provide in the composite pane 20 a section 24 having an increased light transmissivity by comparison with the adjoining section 25, the film 23 is subjected to laser irradiation section by section. In the section 25 by virtue of the film 23 not being subjected to laser irradiation after extruding, the composite pane 20 has a low light transmissivity. In the section 24, by contrast, the composite pane 20 has a high light transmissivity since the film 23 was subjected to laser treatment in this section after extruding.

If the composite pane 20 in FIGS. 2, 3 is a rear window, the section 24 having an increased light transmissivity is configured for positioning a brake luminaire in the region of said section.

By contrast, if the composite pane 20 is a windshield in which, adjacent to the upper roof edge, the light transmissivity thereof is reduced by a so-called gray tinted strip, the region 24 is provided for arranging a camera in the region thereof, and thus for increasing the light transmissivity of the windshield in the region of the so-called gray tinted strip for the camera.

While in the case of a rear window the film typically has a low light transmissivity over the whole area between the inner pane and the outer pane and the light transmissivity is reduced in the section 24 in particular for the brake luminaire, in the case of a windshield the film formed between the inner pane and the outer pane is formed in such a way that it has a low light transmissivity exclusively adjacent to the roof edge, namely with formation of the so-called gray tinted strip, in which the section 24 having an increased light transmissivity, in particular for a camera, is then formed.

In the case of a film for a windshield, the at least one colorant is embedded into the film base material preferably exclusively in the region in which the so-called gray tinted strip is intended to be formed. Outside the region of the gray tinted strip, the film base material is extruded without addition or without admixture of the respective colorant. A relatively dark PVB or EVA film base material is used in the region of the gray tinted strip and a relatively light PVB or EVA film base material is used outside the region of the gray tinted strip.

FIG. 4 shows an alternative cross section through an alternative composite pane 20′, in which an intermediate layer composed of two films 23 and a further film 26 positioned between said films 23 is arranged between the inner pane 21 and the outer pane 22. In this case, the film 26 can be a PTE film. The films 23 are produced in the manner described herein.

The present disclosure provides a film for a composite pane of a motor vehicle and a composite pane comprising such a film which has an increased light transmissivity section by section in order to position a camera or a brake luminaire in the region of this section having an increased light transmissivity, for example. After the process of extruding the film, which consists, at least in sections, of a PVB film base material or EVA film base material with at least one embedded colorant, the film is irradiated, in particular by laser irradiation, section by section in order to change the bonding state of the mobile electrons in the outer electron shell of the at least one colorant and thus the light transmissivity in the irradiated sections. The method can be carried out in a simple and reliable manner.

While the subject matter of the present disclosure has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the subject matter of the present disclosure refer to an embodiment and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for producing a film for a composite pane of a motor vehicle, which film serves as an intermediate layer of the composite pane, the method comprising:
providing a polyvinyl butyral (PVB) film base material or an ethylene vinyl acetate copolymer (EVA) film base material,
providing at least one colorant,
mixing the PVB or EVA film base material with the at least one colorant,
liquefying the mixture of the PVB or EVA film base material and the at least one colorant,
extruding the film from the liquefied mixture of the PVB or EVA film base material and the at least one colorant, and
treating the extruded film section by section by irradiating the film in order to form sections of different light transmissivity.

2. The method as claimed in claim 1, wherein in such sections of the extruded film in which the latter is irradiated, the light transmissivity of the extruded film is increased.

3. The method as claimed in claim 1, wherein the PVB or EVA film base material is provided in powder form,
wherein the at least one colorant is provided in powder form, and
wherein the pulverulent PVB or EVA film base material and the at least one pulverulent colorant are mixed.

4. The method as claimed in claim 1, wherein the at least one colorant comprises a mica mineral coated with at least one metal oxide.

5. The method as claimed in claim 1, wherein the at least one colorant comprises at least one metal oxide embedded into a polymer matrix.

6. The method as claimed in claim 4, wherein the at least one colorant comprises a doped metal oxide.

7. The method as claimed in claim 1, wherein the extruded film is treated by laser irradiation section by section using a UV laser or an IR laser.

8. A method for producing a composite pane of a motor vehicle, the method comprising:
performing the method as claimed in claim 1 to provide the film for the composite pane of the motor vehicle,
forming an inner pane,
forming an outer pane, and
arranging, in particular laminating, the film between the inner pane and the outer pane.

9. The method as claimed in claim 8, wherein in order to produce a windshield of a motor vehicle, the film is treated section by section by irradiation in a section behind which a camera of the motor vehicle is arranged in a state installed in the motor vehicle.

10. The method as claimed in claim 8, wherein in order to produce a rear window of a motor vehicle, the film is treated section by section by irradiation in a section behind which a brake luminaire of the motor vehicle is arranged in a state installed in the motor vehicle.

11. A composite pane of a motor vehicle, the composite pane comprising:
an inner pane,
an outer pane, and
an intermediate layer in the form of a film,
wherein the film comprises a polyvinyl butyral (PVB) film base material or an ethylene vinyl acetate copolymer (EVA) film base material and at least one colorant which is embedded in the PVB or EVA film base material, and
wherein the light transmissivity of the film is different in different sections.

12. A composite pane including a film produced by the method as claimed in claim 1.
